(19) United States
(12) Patent Application Publication
(10) Pub. No.: US 2014/0180541 A1
(43) Pub. Date: Jun. 26, 2014

(54) STEERING DEVICE HAVING TILTING AND TELESCOPIC FUNCTION

(71) Applicants: Tae Young Yu, Seoul (KR); Dae Sung Kim, Hwaseong-si (KR); Hyun Cheol Bae, Suwon-si (KR)

(72) Inventors: Tae Young Yu, Seoul (KR); Dae Sung Kim, Hwaseong-si (KR); Hyun Cheol Bae, Suwon-si (KR)

(73) Assignee: HYUNDAI MOTOR COMPANY, Seoul (KR)

(21) Appl. No.: 14/021,472

(22) Filed: Sep. 9, 2013

(30) Foreign Application Priority Data
Dec. 24, 2012 (KR) 10-2012-0152473

(51) Int. Cl. B62D 1/181

(52) U.S. Cl. CPC B62D 1/181
USPC 701/41; 74/493

(57) ABSTRACT

A steering device having a tilting function and a telescopic function that includes a steering handle that is manipulated by a driver to adjust a running direction of a vehicle. A sensing unit is formed in one region of the steering handle and is configured to sense a contact of an object or contact pressure applied thereto. A tilting device and a telescope device are configured to tilt the steering handle or adjust a length of a steering column In addition, a controller is configured to adjust a tilting angle of the steering handle and a length of the steering column by operating the tilting device and the telescope device based on a direction in which a contacted portion moves or a direction in which contact pressure is applied, which is sensed by the sensing unit.

### CROSS-REFERENCE TO RELATED APPLICATION

This application claims priority to and the benefit of Korean Patent Application No. 10-2012-0152473 filed in the Korean Intellectual Property Office on Dec. 24, 2012, the entire contents of which are incorporated herein by reference.

### BACKGROUND

(a) Field of the Invention

The present invention relates to a steering device that has a tilting function and a telescopic function capable of providing an interface that allows for regulating (or adjusting) an angle position of a steering handle and a position of the steering handle in a length direction to allow a user to more easily and effectively set a position of the steering handle.

(b) Description of the Related Art

In general, a steering device of a vehicle is a device that allows a driver to change a running direction of a vehicle according to driver intention. By using the steering device, a driver may change the center of rotation based on which wheels of a vehicle rotate, to drive the vehicle. Steering force and motor or hydraulic auxiliary force generated as the driver manipulates the steering handle are transferred to a rack and pinion mechanism via a steering shaft of a steering column to change a direction of both wheels of a vehicle.

Additionally, the steering device of a vehicle has a telescope or tilt function added to a steering column to enhance driver convenience. The tilt function is a function that regulates a fixed angle of a steering handle and the telescopic function is a function that increases or decreases a length of the steering column in a length direction. Thus, the steering column may be divided into a telescope or tilt steering column and a tilt function may be added to the telescope steering column.

Meanwhile, a tilting switch for tilting the steering handle or a telescope switch for telescoping the steering handle is required to be operated, and thus, it may be difficult for a driver to optimally adjust a position of the steering handle. Therefore, interfaces for optimally adjusting a position of a steering hand have continued to be developed.

The above information disclosed in this Background section is only for enhancement of understanding of the background of the invention and therefore it may contain information that does not form the prior art that is already known in this country to a person of ordinary skill in the art.

### SUMMARY

The present invention provides a steering device that has a tilting function and a telescopic function having advantages of providing functionality and convenience by allowing a driver holding a steering handle to optimally adjust a position thereof. An exemplary embodiment of the present invention provides a steering device that has a tilting function and a telescopic function, including: a steering handle manipulated by a driver to adjust a running direction of a vehicle; a sensing unit formed in one region of the steering handle configured to sense a contact of a different object or contact pressure applied thereto; a tilting device and a telescope device configured to tilt the steering handle or adjust a length of a steering column; and a controller configured to adjust a tilting angle of the steering handle and a length of the steering column by operating the tilting device and the telescope device based on a direction in which a contacted portion moves or a direction in which contact pressure is applied, which is sensed by the sensing unit.

Furthermore, the sensing unit may be formed along an outer circumferential surface of the steering handle at a predetermine section of the steering handle in a rotation direction. In addition, the sensing unit may be formed in both sides of the steering handle such that they correspond to the driver's hands. The sensing unit may include a front sensor formed in a front portion where the driver is present and a rear sensor formed behind the front portion. The steering device may further include an operating button configured to activate or deactivate an operation of the sensing unit.

The sensing unit may include: a malfunction sensor configured to activate or deactivate a sensing function based on a contact state of a different object; and an operation sensor configured to sense a direction in which a contacted portion moves or a direction in which contact pressure is applied based on the sensing function activated by the malfunction sensor.

The operation sensor may be configured to tilt the steering handle or decrease or increase a length of the steering column based on a direction in which a contact portion moves, based on a direction in which contact pressure is applied, or based on a number of contacts.

The malfunction sensor may be configured to activate the sensing function while a contact of a different object is maintained. The malfunction sensor may be formed in a portion corresponding to the driver's palm, and the operation sensor may be formed in a portion corresponding to the driver's thumb.

In one embodiment of the steering device that has a tilting function and a telescopic function, a driver, that grasps the sensing units formed in both sides of the steering handle, may move the steering handle based on a direction in which force is applied to the sensing unit and a direction in which a contact applied to the sensing unit moves, to thereby more easily and effectively execute the tilting function and the telescopic function of the steering handle.

### BRIEF DESCRIPTION OF THE DRAWINGS

FIG. 1A is an exemplary schematic view that illustrates a configuration of a steering device that has a tilting function and a telescopic function according to an exemplary embodiment of the present invention;

FIG. 1B is an exemplary partial cross-sectional view of the steering device taken along line I-I in FIG. 1A according to an exemplary embodiment of the present invention;

FIG. 2 is an exemplary flow chart that illustrates a process of a method for operating the steering device that has a tilting function and a telescopic function according to an exemplary embodiment of the present invention;

FIG. 3 is an exemplary side view that illustrates a method of operating the steering device that has a tilting function and a telescopic function according to an exemplary embodiment of the present invention.

FIG. 4 is an exemplary view schematically that illustrates positions of a malfunction sensor and an operation sensor of the steering device that has a tilting function and a telescopic function according to an exemplary embodiment of the present invention; and

FIGS. 5A-5D are exemplary views that illustrates a method for operating the operation sensor of the steering device that has a tilting function and a telescopic function according to an exemplary embodiment of the present invention.

### DETAILED DESCRIPTION OF THE EMBODIMENTS

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

An exemplary embodiment of the present invention will hereinafter be described in detail with reference to the accompanying drawings.

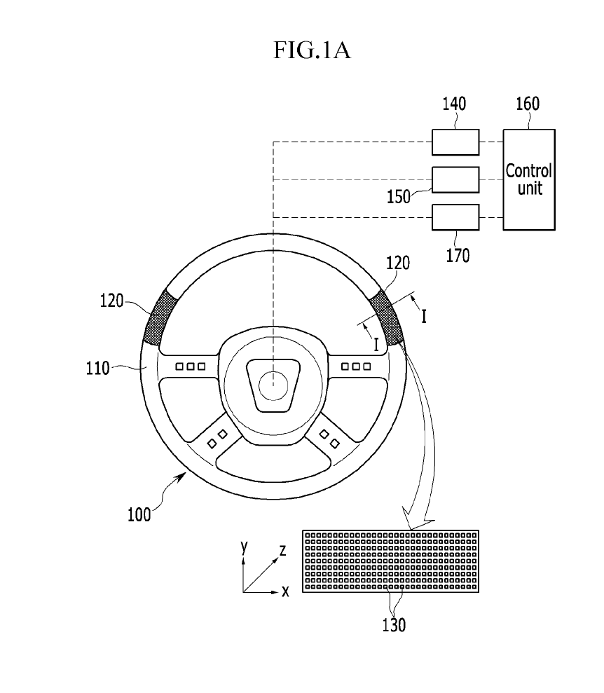

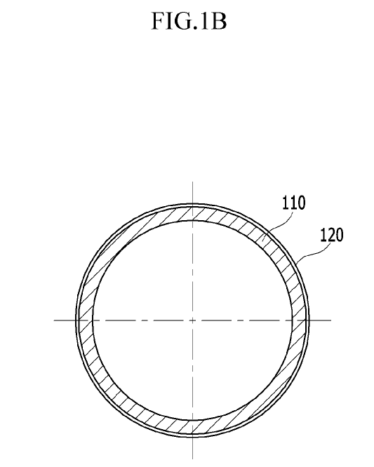

FIG. 1A is an exemplary schematic view illustrating a configuration of a steering device that has a tilting function and a telescopic function according to an exemplary embodiment of the present invention, and FIG. 1B is an exemplary partial cross-sectional view of the steering device taken along line I-I in FIG. 1A.

Referring to FIG. 1A, a steering device 100 may include a steering handle 110, a sensing unit 120, a telescope device 140, a tilting device 150, an operating switch 170, and a controller 160. The sensing unit 120 may include a plurality of sensors 130.

The sensing unit 120 may be formed in a front portion and a rear portion of the steering handle 110. As illustrated in FIG. 1B, the sensing unit 120 may be continuously formed along the outer circumferential surface of the steering handle 110. In addition, the sensing unit 120 may be formed to have a predetermined length in a rotation direction of the steering handle 110. Also, the sensing unit 120 may be formed in both sides of the steering handle 110 such that they correspond to both hands of a driver. The sensing unit 120 may be configured to sense a contact of an external object. In particular, the sensing unit 120 may be configured to sense a contact of an external object or a contact pressure applied thereto. In addition, the controller 160 may be configured to sense a direction in which a contact point moves and a direction in which a contact pressure is applied, through a contact or contact pressure signal sensed by the sensing unit 120.

The sensing unit 120 may include a plurality of sensors, and the sensors may be configured to sense a contact state of a driver's hand, as an electrical signal, in an electrostatic induction manner. Alternatively, the sensing unit 120 may be configured to sense pressure of the driver's hand applied to the sensing unit 120, as an electrical signal.

The driver may operate the operating switch 170 to tilt or telescope the steering handle 110. In another embodiment, the operating switch 170 may be divided into a tilting switch and a telescope switch.

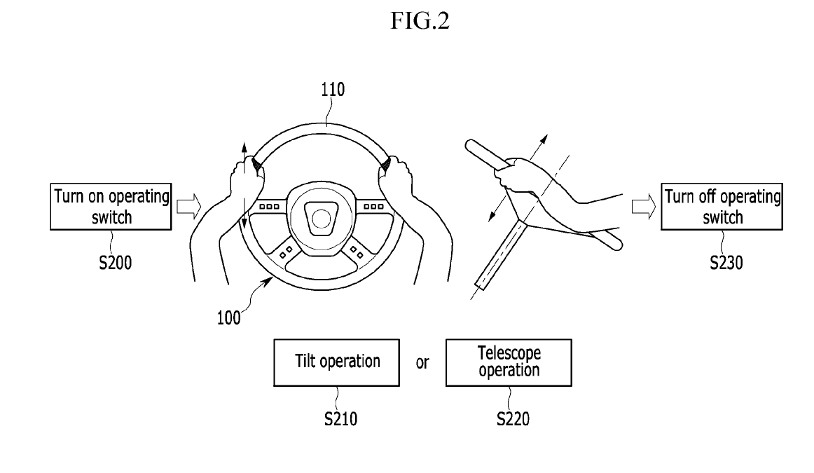

FIG. 2 is an exemplary flow chart that illustrates a process of a method for operating the steering device that has a tilting function and a telescopic function according to an exemplary embodiment of the present invention. Referring to FIG. 2, the operating switch 170 may be operated in step S200 and the sensing unit 120 of the steering handle 110 may be held and moved to a desired position or force may be applied thereto by a driver in step S210.

In particular, through a contact signal or a pressure signal sensed by the sensing unit 120, the controller 160 may be configured to calculate/sense a direction in which the driver's hand moves or a direction in which force is applied, and operate a driving motor of the telescope device 140 and the tilting device 150. Thus, an angle of the steering handle 110 may be adjusted in step S210 and a length of a steering column in which the steering handle 110 is installed may be increased or decreased in step S220.

When the adjusting of the angle of the steering handle 110 and the length of the steering column is completed in steps S210 and S220, the operating switch 170 may be turned off in step S230.

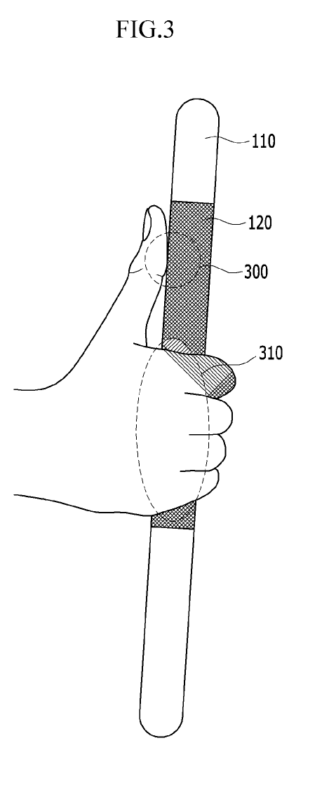

FIG. 3 is an exemplary side view illustrating a method of operating the steering device that has a tilting function and a telescopic function according to an exemplary embodiment of the present invention. Referring to FIG. 3, the sensing unit 120 may be formed in the steering handle 110, and the sensing unit 120 may include a malfunction sensor 310 that may be tightly attached to the driver's palm and an operation sensor 300 that may be tightly attached to the driver's thumb.

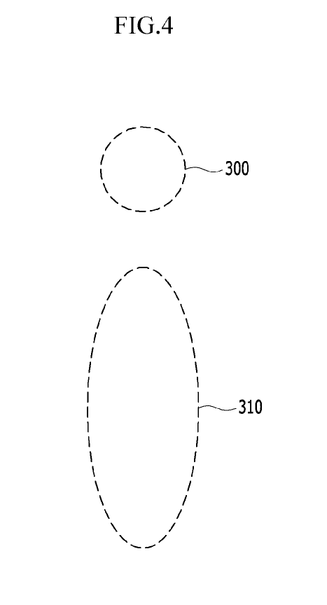

FIG. 4 is an exemplary view schematically illustrating positions of a malfunction sensor and an operation sensor of the steering device that has a tilting function and a telescopic function according to an exemplary embodiment of the present invention. Referring to FIG. 4, the malfunction sensor 310 may be formed at a position corresponding to the driver's palm and the operation sensor 300 may be formed at a position corresponding to the driver's thumb, when the driver grasps the steering handle 110.

The malfunction sensor 310 and the operation sensor 300 may be integrally connected, or as illustrated in FIG. 4, the malfunction sensor 310 and the operation sensor 300 may be formed to be vertically spaced apart at a pre-set interval. In addition, the malfunction sensor 310 and the operation sensor 300 may be formed to have different colors, touches, and positions to allow the driver to easily recognize them.

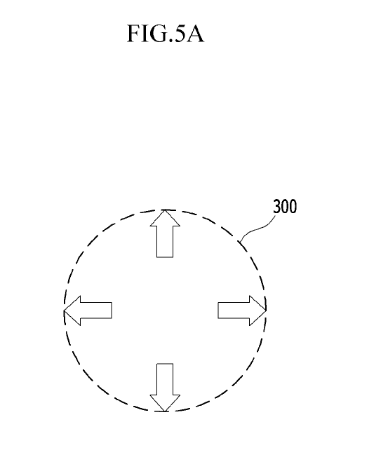

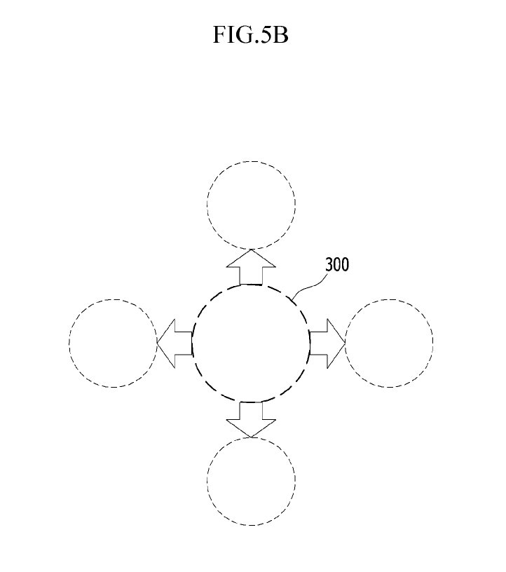

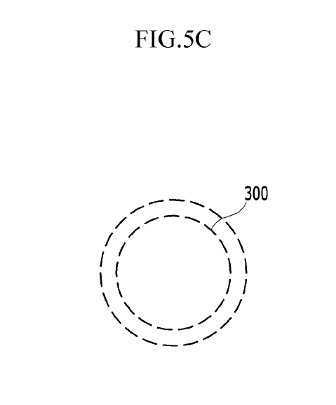

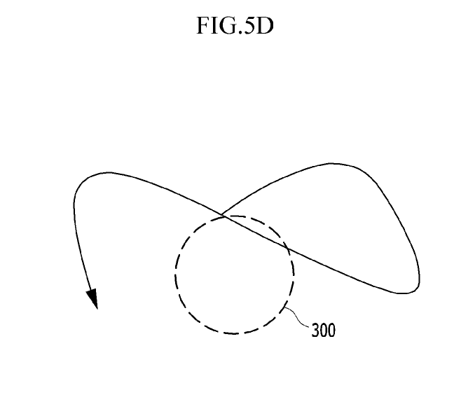

FIGS. 5A, 5B, 5C, and 5D are exemplary views that illustrate a method for operating the operation sensor of the steering device that has a tilting function and a telescopic function according to an exemplary embodiment of the present invention.

Referring to FIG. 5A, when the operation sensing unit 300 is pressed by a driver's thumb or when force is applied horizontally or vertically by the driver, the operation sensor 300 may be configured to transmit a sensed signal to the controller 160 and the controller 160 may be configured to calculate/sense a direction in which the force is applied. The controller 160 may be configured to adjust an angle of the steering handle 110 or decrease/increase a length of the steering column based on the direction in which force is applied.

Referring to FIG. 5B, when the operation sensor 300 is pressed by a driver's thumb or when a horizontal or vertical movement of the driver's thumb is sensed, the operation sensor 300 may be configured to transmit a sensed signal to the controller 160 and the controller 160 may be configured to calculate/sense a movement direction of the driver's thumb. The controller 160 may be configured to adjust an angle of the steering handle 110 or decrease/increase a length of the steering column based on the movement direction of the driver's thumb.

Referring to FIG. 5C, when the operation sensor 300 is pressed by the driver's thumb, when the pressing force is changed, or a single touch (or one click) or a double touch (or double clicks) by the driver is sensed, the operation sensor 300 may be configured to transmit a sensed signal to the controller 160 and the controller 160 may be configured to calculate/sense the pressing force, the one click or double clicks, or the like, applied by the driver's thumb. Additionally, the controller may be configured to adjust an angle of the steering handle 110 or decrease/increase a length of the steering column based on the magnitude of the pressing force, the one click or the double clicks.

Referring to FIG. 5D, when the operation sensor 300 is pressed by the driver's thumb or when a movement of the driver's thumb is sensed along a desired route, the operation sensor 300 may be configured to transmit a sensed signal to the controller 160 and the controller 160 may be configured to calculate/sense a movement direction of the driver's thumb. The controller 160 may be configured to adjust an angle of the steering handle 110 or decrease/increase a length of the steering column based on the movement direction of the driver's thumb.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the accompanying claims.

Description of symbols

| | |
|---|---|
| 100: steering device | 110: steering handle |
| 120: sensing unit | 130: sensors |
| 140: telescope device | 150: tilting device |
| 160: controller | 170: operating switch |

| | |
|---|---|
| 300: operation sensing unit | 310: malfunction sensing unit |

What is claimed is:

1. A steering device that has a tilting function and a telescopic function, the steering device comprising:
a steering handle manipulated by a driver to adjust a running direction of a vehicle;
a sensing unit formed in one region of the steering handle and configured to sense a contact of a different object or contact pressure applied thereto;
a tilting device and a telescope device configured to tilt the steering handle or adjust a length of a steering column; and
a controller configured to adjust a tilting angle of the steering handle and a length of the steering column by operating the tilting device and the telescope device based on a direction in which a contacted portion moves or a direction in which contact pressure is applied, which is sensed by the sensing unit.

2. The steering device of claim 1, wherein the sensing unit is formed along an outer circumferential surface of the steering handle.

3. The steering device of claim 1, wherein the sensing unit is formed at a predetermined section of the steering handle in a rotation direction.

4. The steering device of claim 1, wherein the sensing unit is formed in both sides of the steering handle to correspond to the driver's hands.

5. The steering device of claim 1, wherein the sensing unit includes:
a front sensor formed in a front portion where the driver is present; and
a rear sensor formed behind the front portion.

6. The steering device of claim 1, further comprising:
an operating button configured to activate or deactivate an operation of the sensing unit.

7. The steering device of claim 1, wherein the sensing unit includes:
a malfunction sensor configured to activate or deactivate a sensing function based on a contact state of a different object; and
an operation sensor configured to sense a direction in which a contacted portion moves or a direction in which contact pressure is applied based on the sensing function activated by the malfunction sensor.

8. The steering device of claim 7, wherein the operation sensor is configured to tilt the steering handle or decrease or increase length of the steering column based on a direction in which a contact portion moves based on a direction in which contact pressure is applied, or based on a number of contacts.

9. The steering device of claim 7, wherein the malfunction sensor is configured to activate the sensing function while a contact of a different object is maintained.

10. The steering device of claim 7, wherein the malfunction sensor is formed in a portion corresponding to the driver's palm, and the operation sensor is formed in a portion corresponding to the driver's thumb.

11. A method of operating a steering device that has a tilting function and a telescope function, the method comprising:
receiving, at a controller, a contract signal or a pressure signal sensed by a sensing unit;
calculating, by the controller, a movement direction of a contacted portion or a direction in which a contact pressure is applied; and
operating, by the controller, a driving motor of a telescope device and a tilting device to adjust the angle of the steering handle and to decrease or increase a length of a steering column in which the steering handle is installed based on the calculation.

12. The method of claim 11, wherein the sensing unit is formed along an outer circumferential surface of the steering handle.

13. The method of claim 11, wherein the sensing unit is formed at a predetermined section of the steering handle in a rotation direction.

14. The method of claim 11, wherein the sensing unit is formed in both sides of the steering handle to correspond to the driver's hands.

15. The method of claim 11, wherein the sensing unit includes:
a front sensor formed in a front portion where the driver is present; and
a rear sensor formed behind the front portion.

16. The method of claim 11, wherein the sensing unit includes:
a malfunction sensor configured to activate or deactivate a sensing function based on a contact state of a different object; and
an operation sensor configured to sense a direction in which the contacted portion moves or the direction in which contact pressure is applied based on the sensing function activated by the malfunction sensor.

17. A non-transitory computer readable medium containing program instructions executed by a processor or controller, the computer readable medium comprising:
program instructions that receive a contract signal or a pressure signal sensed by a sensing unit;
program instructions that calculate a movement direction of a contacted portion or a direction in which a contact pressure is applied; and
program instructions that operate a driving motor of a telescope device and a tilting device to adjust the angle of the steering handle and to decrease or increase a length of a steering column in which the steering handle is installed based on the calculation.

18. The non-transitory computer readable medium of claim 17, wherein the sensing unit is formed along an outer circumferential surface of the steering handle.

19. The non-transitory computer readable medium of claim 17, wherein the sensing unit is formed at a predetermined section of the steering handle in a rotation direction.

20. The non-transitory computer readable medium of claim 17, wherein the sensing unit includes:
a front sensor formed in a front portion where the driver is present; and
a rear sensor formed behind the front portion.
